(19) United States
(12) Patent Application Publication
(10) Pub. No.: US 2017/0099476 A1
(43) Pub. Date: Apr. 6, 2017

(54) PHOTOGRAPHING DEVICE AND METHOD OF CONTROLLING THE SAME

(71) Applicant: SAMSUNG ELECTRONICS CO., LTD., Suwon-si (KR)

(72) Inventors: Il-do KIM, Suwon-si (KR); Soon-geun JANG, Suwon-si (KR)

(21) Appl. No.: 15/206,525

(22) Filed: Jul. 11, 2016

Related U.S. Application Data
(60) Provisional application No. 62/235,696, filed on Oct. 1, 2015.

(30) Foreign Application Priority Data
Oct. 15, 2015 (KR) 10-2015-0144312

(51) Int. Cl. H04N 9/64; H04N 5/33; G06T 7/00; G06T 5/50; H04N 5/232; H04N 9/09

(52) U.S. Cl. CPC H04N 9/646; H04N 5/23232; H04N 9/09; G06T 7/0085; G06T 5/50; H04N 5/332; G06T 2207/10024; G06T 2207/10048

(57) ABSTRACT

A method of controlling a photographing device comprising a plurality of image sensors includes generating color image data from a first image sensor photographing a subject and generating grey image data from a second image sensor photographing the subject, extracting a first edge from the color image data and extracting a second edge from the grey image data, combining the first edge with the second edge to generate a third edge, and combining the third edge with the color image data to generate resultant image data.

### CROSS-REFERENCE TO RELATED APPLICATIONS

This application is based on and claims priority under 35 U.S.C. §119 to U.S. Provisional Application No. 62/235,696, filed on Oct. 1, 2015, in the US Patent Office and Korean Patent Application No. 10-2015-0144312, filed on Oct. 15, 2015, in the Korean Intellectual Property Office, the disclosures of which are incorporated by reference herein in their entireties.

### BACKGROUND

1. Field

The present disclosure relates to a photographing device and a method of controlling the same.

2. Description of Related Art

User's eyes do not perceive light of infrared and near-infrared wavelength bands, but when light of the infrared and near-infrared wavelength bands is used to generate image data of a photographing device, it is possible to obtain high-resolution images.

However, in the case of using light of the infrared wavelength band, since light belonging to a portion of the visible wavelength band, for example, the red color series wavelength band reacts to light of the infrared and near-infrared wavelength bands more sensitively than light belonging to the remainder of the visible wavelength band, the color and brightness of a photographed image are exaggerated, thereby making the photographed image awkward. Accordingly, a method is being developed which prevents distortion of color while generating image data of high resolution using light of the infrared wavelength band.

### SUMMARY

A photographing device that creates an image of high resolution using light of an infrared wavelength band and photographs an image to allow the color have reduced distortion and a method of controlling the same are provided.

Additional aspects will be set forth in part in the description which follows and, in part, will be apparent from the description.

According to an aspect of an example embodiment, a method of controlling a photographing device that includes a plurality of image sensors includes generating color image data from a first image sensor photographing a subject and generating grey image data from a second image sensor photographing the subject, extracting a first edge from the color image data and extracting a second edge from the grey image data, combining the first edge with the second edge to generate a third edge, and combining the third edge with the color image data to generate resultant image data.

The combining of the first edge with the second edge may include determining a weight of the first edge and a weight of the second edge, respectively, based on a difference between a visible ray reflectance and an infrared reflectance of the subject, and combining the first edge with the second edge based on the weight of the first edge and the weight of the second edge.

The weight of the first edge may be determined to be greater than the weight of the second edge when the difference between the visible ray reflectance and the infrared reflectance of the subject is greater than a threshold value.

The weight of the first edge may be determined to be less than the weight of the second edge when the difference between the visible ray reflectance and the infrared reflectance of the subject is less than the threshold value.

The weight of the first edge may be determined differently with respect to areas in which reflectance differences between visible rays and infrared rays are different from each other in the subject.

The weight of the first edge may be determined based on the difference between the visible ray reflectance and the infrared reflectance of the subject obtained from the color image data or the grey image data.

The weight of the first edge may be determined based on the difference between the visible ray reflectance and the infrared reflectance of the subject obtained from a database.

The grey image data may be generated using infrared rays incident on the photographing device through a lens.

The grey image data may be generated by radiating infrared rays on the subject using an infrared flash.

An amount of infrared rays radiated from the infrared flash is adjustable.

According to an aspect of another example embodiment, a photographing device that includes a plurality of image sensors includes a first image sensor configured to generate color image data from a subject, a second image sensor configured to generate grey image data from the subject, and a processor configured to extract a first edge from the color image data, to extract a second edge from the grey image data, to combine the first edge with the second edge to generate a third edge, and to combine the third edge with the color image data to generate resultant image data.

The processor may be configured to determine a weight of the first edge and a weight of the second edge, respectively, based on a difference between a visible ray reflectance and an infrared reflectance of the subject and may combine the first edge with the second edge based on the weight of the first edge and the weight of the second edge.

The processor may be configured to determine the weight of the first edge to be greater than the weight of the second edge when the difference between the visible ray reflectance and the infrared reflectance of the subject is greater than a threshold value, and the processor may be configured to determine the weight of the first edge to be less than the weight of the second edge when the difference between the visible ray reflectance and the infrared reflectance of the subject is less than the threshold value.

The weight of the first edge may be determined differently with respect to areas in which reflectance differences between visible rays and infrared rays are different from each other in the subject.

The weight of the first edge may be determined based on the difference between the visible ray reflectance and the infrared reflectance of the subject that are obtained from the color image data or the grey image data.

The weight of the first edge may be determined based on the difference between the visible ray reflectance and the infrared reflectance of the subject obtained from a database.

The grey image data may be generated using infrared rays incident on the photographing device through a lens.

The photographing device may further include an infrared flash, and the grey image data may be generated by radiating infrared rays on the subject using the infrared flash.

The photographing device may further include an infrared flash that radiates infrared rays on the subject.

An amount of infrared rays radiated from the infrared flash is adjustable.

According to an aspect of still another example embodiment, a non-transitory computer-readable recording medium stores computer program codes. The computer program codes, when read and executed by a processor, cause the processor to perform a method of controlling a photographing device including a plurality of image sensors. The method includes generating color image data from a first image sensor photographing a subject and generating grey image data from a second image sensor photographing the subject, extracting a first edge from the color image data and extracting a second edge from the grey image data, combining the first edge and the second edge to generate a third edge, and combining the third edge with the color image data to generate resultant image data.

According to an aspect of still another example embodiment, a photographing device that includes a plurality of image sensors includes a plurality of image sensors configured to generate color image data and a grey image from a subject, respectively, and a processor configured to extract edge information from each of the color image data and the grey image data and to apply the extracted edge information of the color image data and the extracted edge information of the grey image data to the color image data to generate resultant image data.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a schematic block diagram illustrating an example photographing device in a network environment according to various example embodiments;

FIG. 2 is a block diagram illustrating an example photographing device 201 according to various example embodiments;

FIG. 3 is a block diagram illustrating an example program module according to various example embodiments;

FIG. 4 is a diagram illustrating example image data generated in photographing a subject under the condition that infrared rays are cut off.

FIG. 5 is a diagram illustrating an example of image data generated when photographing is made according to an example embodiment;

FIG. 6 is a block diagram illustrating an example photographing device according to an example embodiment;

FIG. 7 is a flowchart illustrating an example method of controlling a photographing device, according to an example embodiment;

FIG. 8 is a schematic diagram illustrating an example photographing device equipped with a plurality of sensors, according to an example embodiment;

FIG. 9A is a block diagram illustrating an example photographing device according to an example embodiment;

FIG. 9B is a schematic diagram illustrating an example photographing device equipped with a plurality of sensors, according to an example embodiment;

FIG. 10A is a diagram illustrating an example method of determining a weight of a first edge based on a property of a subject, according to an example embodiment;

FIG. 10B is a diagram illustrating an example method of determining a weight of a first edge based on a property of a subject, according to another example embodiment;

FIG. 10C is a diagram illustrating an example method of determining a weight of a first edge based on a property of a subject, according to still another example embodiment; and

FIG. 11 is a block diagram illustrating an example photographing device equipped with a plurality of sensors, according to an example embodiment.

### DETAILED DESCRIPTION

Reference will now be made in greater detail to example embodiments, examples of which are illustrated in the accompanying drawings, wherein like reference numerals refer to like elements throughout. In this regard, the example embodiments may have different forms and should not be construed as being limited to the descriptions set forth herein. Accordingly, the example embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not necessarily modify the individual elements of the list.

Various example embodiments disclosed herein will be described with reference to accompanying drawings. However, it should be understood that the description disclosed in this description is not limited to any specific embodiment and that modifications, equivalents, and/or alternatives of the various example embodiments described herein are included in the contents of this description. With regard to description of drawings, similar elements may be marked by similar reference numerals.

Although certain general terms widely used at present are selected to describe various example embodiments based on the functions thereof, these general terms may vary according to intentions of one of ordinary skill in the art, case precedents, the advent of new technologies, and the like. Terms may have been arbitrarily selected and may also be used in a specific case. In this case, their meanings are given in the detailed description of the example embodiments. Hence, these terms may be defined based on their meanings and the contents of the entire specification, not by simply stating the terms.

The term “unit” used herein may refer to software or hardware such as field programmable gate array (FPGA), processing circuitry (e.g., a CPU) or application specific integrated circuit (ASIC), or the like, and the “unit” may perform some functions. However, the “unit” may be not limited to software or hardware. The “unit” may be configured to exist in an addressable storage medium or may be configured to reproduce one or more processors. Therefore, as an example, “units” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” and elements may be combined into a smaller number of “units” and elements or may be divided into additional “units” and elements.

In this description, a mobile device may refer, for example, to a computer device of a relatively small size, which a user carries, such as a mobile telephone, a personal digital assistant (PDA), or a laptop, or the like.

In this description, the expressions “have”, “may have”, “include” and “comprise”, or “may include” and “may comprise” used herein indicate existence of corresponding features (e.g., elements such as numeric values, functions, operations, or components) but do not exclude presence of additional features.

In this description, the expressions “A or B”, at least one of A or/and B″, one or more of A or/and B″, and the like may include all combinations of the associated listed items. For example, the term “A or B”, at least one of A and B″, or at least one of A or B″ may refer to all of the case (1) where at least one A is included, the case (2) where at least one B is included, or the case (3) where both of at least one A and at least one B are included.

The terms such as “first”, “second”, and the like used herein may refer to various elements regardless of the order and/or priority of the elements and may be used to distinguish an element from another element, not to limit the elements. For example, “a first user device” and “a second user device” may indicate different user devices regardless of the order or priority thereof. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a general-purpose processor (e.g., a central processing unit (CPU) or an application processor) which performs corresponding operations by executing one or more software programs which are stored in a memory device.

In this description, the term “transmittance” may refer, for example, to a value indicating how much light incident on an object is transmitted through the object. Also, in this description, the term “reflectance” may refer, for example, to a value indicating how much light incident on the object is reflected from a surface of the object.

In this description, a grey image may refer, for example, to an image of which the grey value is expressed with a magnitude and without using an RGB color model.

Terms used in this description may be used to describe various example embodiments and may not be intended to limit other example embodiments. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary, should also be interpreted as is customary in the relevant related art and not in an idealized or overly formal meaning unless expressly so defined herein in this description. In some cases, even if terms are terms that are defined in the description, they may not be interpreted to exclude example embodiments of this disclosure.

A photographing device according to various example embodiments may include, for example, at least one of smartphones, tablet personal computers (PCs), mobile phones, video telephones, electronic book readers, desktop PCs, laptop PCs, notebook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices, or the like. According to various example embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit), or the like.

According to various example embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, a home automation control panel, a security control panel, TV boxes (e.g., Samsung HomeSync™, Apple TV™, or Google TV™), game consoles (e.g., Xbox™ and PlayStation™), electronic dictionaries, electronic keys, camcorders, or electronic picture frames, or the like.

In another example embodiment, the photographing device may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to an example embodiment, the photographing device may include at least one of parts of furniture or buildings/structures, electronic boards, electronic signature receiving devices, projectors, or various measuring instruments (e.g., water meters, electricity meters, gas meters, or wave meters, and the like), or the like. In various example embodiments, the photographing device may be one of the above-described devices or a combination of one or more thereof. A photographing device according to an example embodiment may be a flexible electronic device. In addition, the photographing device according to an example embodiment may not be limited to the above-described devices and may include electronic devices that are produced according to the development of technologies.

Hereinafter, a photographing device according to various example embodiments will be described with reference to the accompanying drawings. The term “user” used herein may refer to a person who uses the photographing device or may refer to a device (e.g., an artificial electronic device) that uses the photographing device.

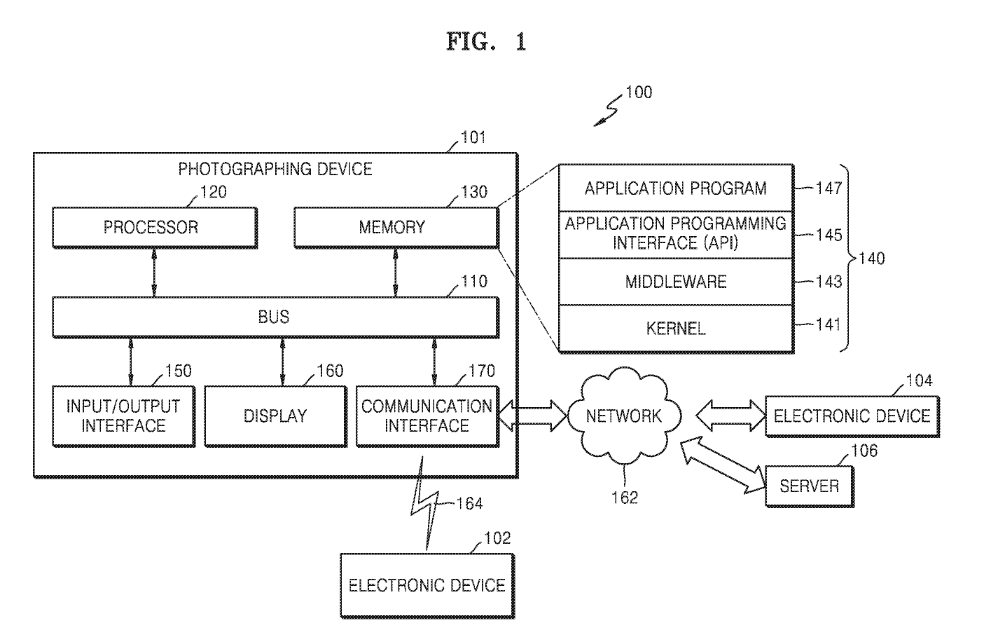

FIG. 1 is a block diagram illustrating an example photographing device in a network environment according to various example embodiments. The photographing device 101 may include a bus 110, a processor 120, a memory 130, an input/output (I/O) interface (e.g., including input/output circuitry) 150, a display 160, and a communication interface (e.g., including communication circuitry) 170. According to an example embodiment, the photographing device 101 may not include one or more of the above-described elements or may further include any other element(s).

For example, the bus 110 may interconnect the above-described elements 120 to 170 and may include a circuit for conveying communications (e.g., a control message and/or data) among the above-described elements.

The processor 120 may include one or more of a central processing unit (CPU), an application processor (AP), or a communication processor (CP). The processor 120 may be configured to perform, for example, data processing or an operation associated with control or communication of at least another element of the photographing device 101.

The memory 130 may include a volatile and/or non-volatile memory. For example, the memory 130 may store instructions or data associated with at least another element of the photographing device 101. According to an example embodiment, the memory 130 may store software and/or a program 140.

The program 140 may include, for example, a kernel 141, a middleware 143, an application programming interface (API) 145, and/or an application program (or “application”) 147. At least a portion of the kernel 141, the middleware 143, or the API 145 may be referred to as an “operating system (OS)”.

The I/O interface 150 may serve as, for example, an interface of transmitting an instruction or data, which is input by a user or another external device, to another element of the photographing device 101. In addition, the I/O interface 150 may output an instruction or data, which is received from another element of the photographing device 101, to a user or another external device.

The display 160 may include, for example, a liquid crystal display (LCD), a light-emitting diode (LED) display, an organic LED (OLED) display, or a microelectromechanical systems (MEMS) display, or an electronic paper display, or the like. The display 160 may display, for example, various kinds of content (e.g., a text, an image, a video, an icon, a symbol, and the like) to a user. The display 160 may include a touch screen and may receive, for example, a touch input, a gesture input, a proximity input, or a hovering input using an electronic pen or a portion of a user's body, etc.

The communication interface 170 may include communication circuitry to establish, for example, communication between the photographing device 101 and an external device (e.g., a first external electronic device 102, a second external electronic device 104, or a server 106). For example, the communication interface 170 may be connected to the network 162 through wireless communication or wired communication and may communicate with an external device (e.g., the second external device 104 or the server 106).

The wireless communication may include various communication circuitry, including at least one of, for example, LTE (long-term evolution), LTE-A (LTE Advance), CDMA (Code Division Multiple Access), WCDMA (Wideband CDMA), UMTS (Universal Mobile Telecommunications System), WiBro (Wireless Broadband), or GSM (Global System for Mobile Communications), or the like, as a cellular communication protocol. In addition, the wireless communication may include, for example, a local area network 164. The local area network 164 may include at least one of a wireless fidelity (Wi-Fi), a near field communication (NFC), a global navigation satellite system (GNSS), or the like. The GNSS may include at least one of a global positioning system (GPS), a global navigation satellite system (Glonass), Beidou Navigation Satellite System (hereinafter referred to as “Beidou”), or the European global satellite-based navigation system (Galileo). In this specification, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 162 may include at least one of telecommunications networks, for example, a computer network (e.g., LAN or WAN), an Internet, or a telephone network.

Each of the external first and second external electronic devices 102 and 104 may be a device of which the type is different from or the same as that of the photographing device 101. According to an example embodiment, the server 106 may include a server or a group of two or more servers. According to various example embodiments, all or a part of operations that the photographing device 101 may perform may be executed by another or plural electronic devices (e.g., the first or second external electronic device 102 or 104 or the server 106). According to an example embodiment, in the case where the photographing device 101 executes any function or service automatically or in response to a request, the photographing device 101 may not perform the function or the service therein, but, alternatively or additionally, it may request at least a portion of a function associated with the photographing device 101 from any other device (e.g., the first or second external electronic device 102 or 104 or the server 106). The other electronic device (e.g., the first or second external electronic device 102 or 104 or the server 106) may execute the requested function or additional function and may transmit the execution result to the photographing device 101. The photographing device 101 may provide the requested function or service using the received result or may additionally process the received result to provide the requested function or service. To this end, for example, cloud computing, distributed computing, or client-server computing may be used.

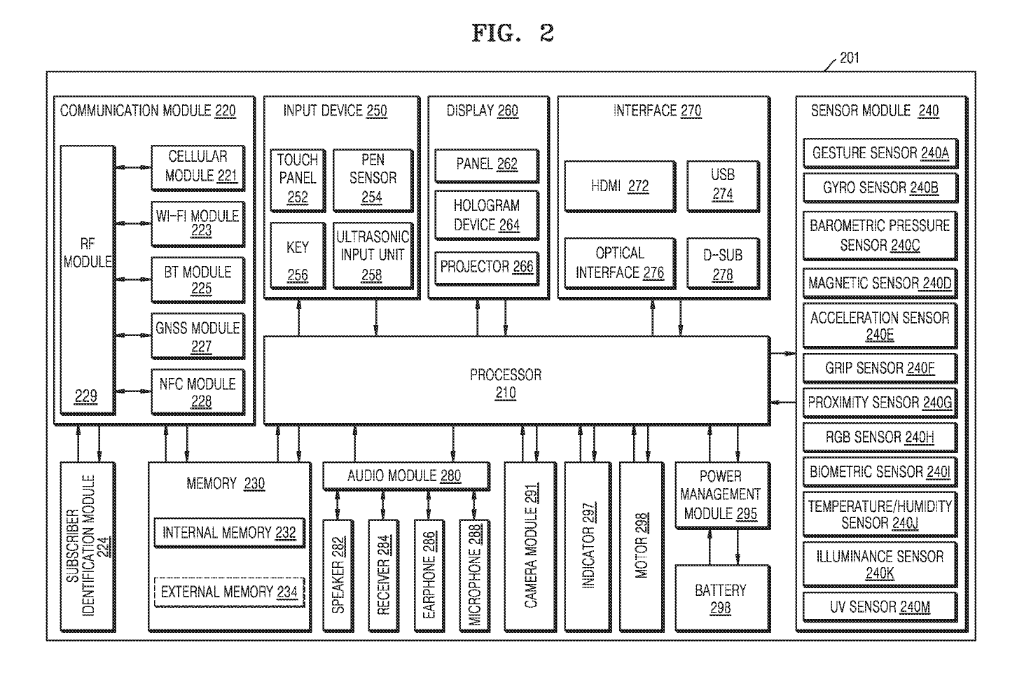

FIG. 2 is a block diagram illustrating an example photographing device 201 according to various example embodiments. Referring to FIG. 2, the photographing device 201 may include, for example, all or a part of the photographing device 101 illustrated in FIG. 1. The photographing device 201 may include one or more processors (e.g., an application processor (AP)) 210, a communication module (e.g., including communication circuitry) 220, a subscriber identification module 224, a memory 230, a sensor module (e.g., including at least one sensor) 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may drive an operating system (OS) or an application to control a plurality of hardware or software elements connected to the processor 210 and may process and compute a variety of data. The processor 210 may be implemented with a System on Chip (SoC), for example. According to an example embodiment, the processor 210 may further include a graphic processing unit (GPU) and/or an image signal processor. The processor 210 may include at least a portion (e.g., a cellular module 221) of elements illustrated in FIG. 2. The processor 210 may load and process an instruction or data, which is received from at least one of other elements (e.g., a non-volatile memory), and may store a variety of data in a non-volatile memory.

The communication module 220 may be configured the same as or similar to a communication interface 170 of FIG. 1. The communication module 220 may include, various communication circuitry, including, for example, a cellular module 221, a Wi-Fi module 223, a Bluetooth (BT) module 225, a GNSS module 227 (e.g., a GPS module, a Glonass module, a Beidou module, or a Galileo module), a near field communication (NFC) module 228, and a radio frequency (RF) module 229.

The memory 230 (e.g., the memory 130) may include an internal memory 232 or an external memory 234. For example, the internal memory 232 may include at least one of a volatile memory (e.g., a dynamic random access memory (DRAM), a static RAM (SRAM), or a synchronous DRAM (SDRAM)), a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 234 may include a flash drive, for example, a compact flash (CF) card, a secure digital (SD) card, a micro secure digital (Micro-SD) card, a mini secure digital (Mini-SD) card, an extreme digital (xD) card, a multimedia card (MMC), a memory stick, or the like. The external memory 234 may be functionally and/or physically connected with the photographing device 201 through various interfaces.

The sensor module 240 may include at least one sensor, and may measure, for example, a physical quantity or may detect an operation status of the photographing device 201. The sensor module 240 may convert the measured or detected information to an electrical signal. The sensor module 240 may include at least one of, for example, a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature/humidity sensor 240J, an illuminance sensor 240K, or an UV sensor 240M. The sensor module 240 may further include a control circuit for controlling at least one or more sensors included therein. According to an example embodiment, the photographing device 201 may further include a processor that is a part of the processor 210 or independent of the processor 210 and is configured to control the sensor module 240. The processor may control the sensor module 240 while the processor 810 remains in a sleep state.

The input device 250 may include various input circuitry, for example, a touch panel 252, a (digital) pen sensor 254, a key 256, or an ultrasonic input unit 258. The touch panel 252 may use at least one of, for example, capacitive, resistive, infrared and ultrasonic detecting methods. Also, the touch panel 252 may further include a control circuit. The touch panel 252 may further include a tactile layer to provide a tactile reaction to a user.

The (digital) pen sensor 254 may be, for example, a part of a touch panel or may include an additional sheet for recognition. The key 256 may include, for example, a physical button, an optical key, a keypad, or the like. The ultrasonic input device 258 may detect (or sense) an ultrasonic signal, which is generated from an input device, through a microphone (e.g., a microphone 288) and may verify data corresponding to the detected ultrasonic signal.

The display 260 (e.g., the display 160) may include a panel 262, a hologram device 264, or a projector 266. The panel 262 may be configured the same as or similar to the display 160 of FIG. 1. The panel 262 may be implemented to be flexible, transparent or wearable, for example. The panel 262 and the touch panel 252 may be integrated into a single module.

The interface 270 may include various interface circuitry, for example, a high-definition multimedia interface (HDMI) 272, a universal serial bus (USB) 274, an optical interface 276, or a D-sub (D-subminiature) 278.

The audio module 280 may convert a sound and an electrical signal in dual directions. At least a part of the audio module 280 may be included, for example, in the input/output interface 150 illustrated in FIG. 1. The audio module 280 may process, for example, sound information that is input or output through a speaker 282, a receiver 284, an earphone 286, or a microphone 288.

The camera module 291 may be a device that captures a still image or video and may include, for example, at least one or more image sensors (e.g., a front sensor or a rear sensor), a lens, an image signal processor (ISP), or a flash (e.g., an LED or a xenon lamp).

The power management module 295 may manage, for example, power of the photographing device 201. According to an example embodiment, the power management module 295 may include a power management integrated circuit (PMIC), a charger IC, or a battery or fuel gauge. The PMIC may have a wired charging method and/or a wireless charging method. The battery gauge may measure, for example, a remaining capacity of the battery 296 and a voltage, current, or temperature thereof while the battery 296 is being charged.

The indicator 297 may display a specific state of the photographing device 201 or a portion thereof (e.g., the processor 210), such as a booting state, a message state, a charging state, or the like. The motor 298 may convert an electrical signal into a mechanical vibration and may generate a vibration, a haptic effect, and the like.

Each of the above-mentioned elements may be configured with one or more components, and the names of the elements may be changed based on a type of electronic device. In various example embodiments, an electronic device may include at least one of the above-mentioned elements. Some elements may be omitted, or other additional elements may be added. In addition, some of the elements of the electronic device according to various example embodiments may be combined with each other so as to form one entity, so that the functions of the elements may be performed in the same manner as before the combination.

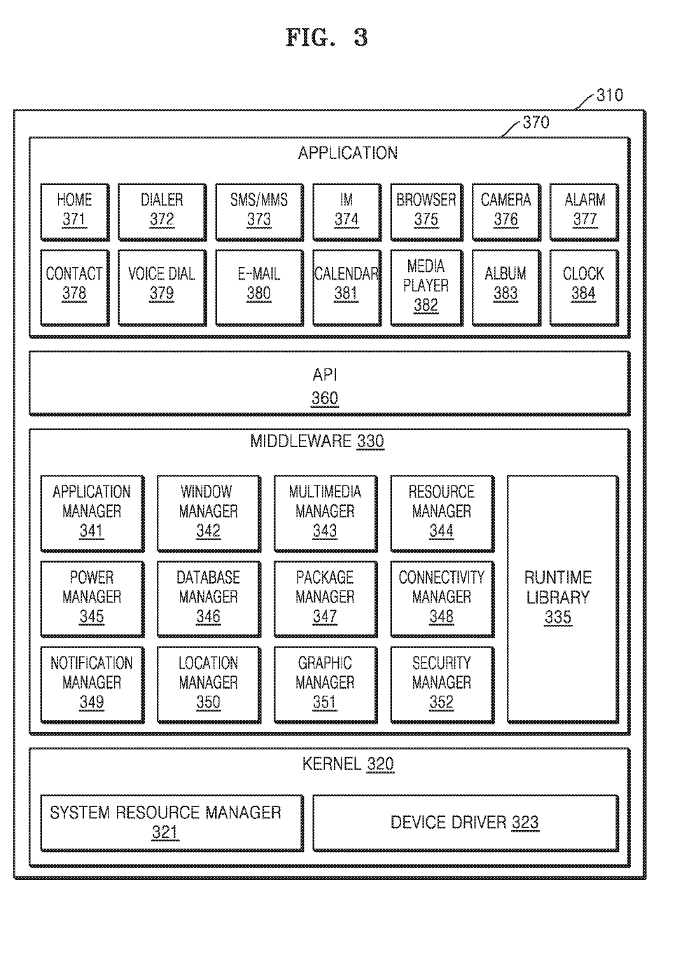

FIG. 3 is a block diagram illustrating an example program module according to various example embodiments. According to an example embodiment, a program module 310 (e.g., the program 140) may include an operating system (OS) to control resources associated with an electronic device (e.g., the photographing device 101), and/or diverse applications (e.g., the application program 147) driven on the OS. The OS may be, for example, android, iOS, windows, symbian, tizen, or bada.

The program module 310 may include, for example, a kernel 320, middleware 330, an application programming interface (API) 360, and/or an application 370. At least a part of the program module 310 may be preloaded on the electronic device or may be downloadable from an external electronic device (e.g., the first or second external electronic device 102 or 104, the server 106, and the like).

The kernel 320 (e.g., the kernel 141) may include, for example, a system resource manager 321 and/or a device driver 323. The system resource manager 321 may perform control, allocation, or retrieval of system resources. According to an example embodiment, the system resource manager 321 may include a process managing part, a memory managing part, or a file system managing part. The device driver 323 may include, for example, a display driver, a camera driver, a BT driver, a common memory driver, an USB driver, a keypad driver, a Wi-Fi driver, an audio driver, or an inter-process communication (IPC) driver.

The middleware 330 may provide, for example, a function that the application 370 needs in common or may provide diverse functions to the application 370 through the API 360 to allow the application 370 to efficiently use limited system resources of the electronic device. According to an example embodiment, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The middleware 330 may include a middleware module that combines diverse functions of the above-described elements. The middleware 330 may provide a module specialized to each OS type to provide different functions. In addition, the middleware 330 may remove a part of the pre-existing elements, dynamically, or may add new elements thereto.

The API 360 (e.g., the API 145) may be, for example, a set of API programming functions and may be provided with a configuration which varies according to an OS. For example, in the case where the OS is android or iOS, it may be permissible to provide one API set per platform. In the case where the OS is tizen, it may be permissible to provide two or more API sets per platform.

The application 370 (e.g., the application program 147) may include, for example, one or more applications such as a home application 371, a dialer application 372, an SMS/MMS application 373, an instant message (IM) application 374, a browser 375, a camera application 376, an alarm application 377, a contact application 378, a voice dial application 379, an e-mail application 380, a calendar application 381, a media player application 382, a media gallery (e.g., album) 383, and a clock application 384, or for offering health care (e.g., measuring an amount of exercise or blood sugar) or environment information (e.g., atmospheric pressure, humidity, or temperature).

According to various example embodiments, at least a portion of the program module 310 may be implemented by software, firmware, hardware, or a combination of two or more thereof. At least a portion of the program module 310 may be implemented (e.g., executed), for example, by a processor (e.g., the processor 210). At least a portion of the program module 310 may include, for example, modules, programs, routines, sets of instructions, or processes, or the like for performing one or more functions.

At least a portion of a device (e.g., modules or functions thereof) or a method (e.g., operations) according to various example embodiments may be, for example, implemented by instructions stored in a computer-readable storage media in the form of a program module. The instruction, when executed by one or more processors (e.g., the processor 120), may cause the one or more processors to perform a function corresponding to the instruction. The computer-readable storage media may be, for example, the memory 130.

A module or a program module according to various example embodiments may include at least one or more of the above-mentioned elements, some of the above-mentioned elements may be omitted, or other additional elements may be further included therein. Operations executed by modules, program modules, or other elements may be executed by a successive method, a parallel method, a repeated method, or a heuristic method. In addition, a portion of operations may be executed in different sequences or may be omitted. Alternatively, other operations may be added. Embodiments disclosed in this specification may be used to describe and help understand technical contents. Accordingly, the embodiments should be interpreted as including all modifications or diverse other embodiments.

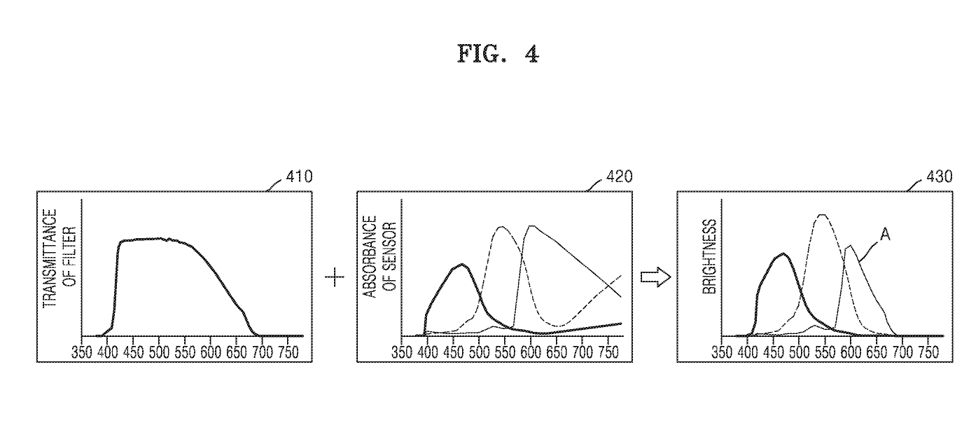

FIG. 4 is a diagram illustrating example image data generated in photographing a subject under the condition that infrared rays are cut off.

Referring to FIG. 4, a graph 410 indicates filter transmittance that corresponds to each of wavelength bands of light and is measured after light reflected from a subject passes through a filter that cuts off infrared and ultraviolet rays. For example, the abscissa of the graph 410 represents a wavelength band of light, and the ordinate thereof represents transmittance of light passing through the infrared and ultraviolet filter(s). A corresponding filter shows about 48% transmittance with respect to light having a long wavelength, for example, light having a wavelength of 625 nm.

A graph 420 indicates absorbance of a sensor, which is included in a photographing device, for each wavelength band of light. In detail, the abscissa of the graph 420 represents a wavelength band of light, and the ordinate thereof represents absorbance of a corresponding sensor to light. The graph 420 shows absorbance about light of a short wavelength, light of a medium wavelength, and light of a long wavelength, respectively.

A graph 430 indicates brightness of each wavelength band of image data that is generated through a filter of the graph 410 and a sensor of the graph 420. Here, the brightness may mean a brightness value that a person is capable of perceiving. The graph 430 shows brightness of light of a short wavelength band, light of a medium wavelength band, and light of a long wavelength band, respectively.

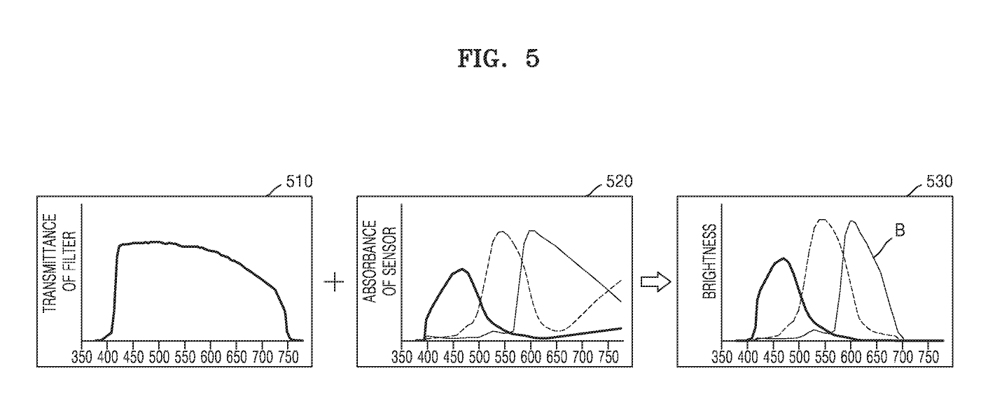

FIG. 5 is a diagram illustrating image data generated when photographing is performed according to an example embodiment.

A graph 510 indicates transmittance for respective wavelength bands of light that are measured after light reflected from a subject passes through a filter for cutting off infrared and ultraviolet rays. For example, the abscissa of the graph 510 represents a wavelength band of light, and the ordinate thereof represents transmittance of light passing through a filter for cutting off infrared and ultraviolet rays. A corresponding subject shows about 92% transmittance with respect to light having a long wavelength, for example, light having a wavelength of 625 nm. For example, it may be understood that with regard to a long wavelength of 625 nm, transmittance of a filter according to an example embodiment is greater than that of a filter of FIG. 4 (having 48% transmittance). Accordingly, image data that is generated when photographing is made under the condition that light of a long-wavelength band such as infrared rays is transmitted much more may be verified through an embodiment disclosed herein.

A graph 520 indicates absorbance of a sensor, which is included in a photographing device, for each wavelength band of light. In detail, the abscissa of the graph 530 represents a wavelength band of light, and the ordinate thereof represents absorbance of a corresponding sensor to light. The graph 530 shows absorbance of light of a short wavelength band, light of a medium wavelength band, and light of a long wavelength band, respectively. Since the same sensor as that of FIG. 4 is used, the graph 520 is identical to the graph 420.

A graph 530 indicates brightness of image data, which is generated through a filter of the graph 510 and a sensor of the graph 520, for each wavelength band. The graph 530 shows brightness of light of a short wavelength band, light of a medium wavelength band, and light of a long wavelength band, respectively. Compared to a long-wavelength band A of the graph 430 of FIG. 4, a long-wavelength band B of the graph 530 may have a great brightness value. The reason is that visible rays of a red series belonging to a relatively long-wavelength band are affected much more by infrared rays. As such, the color of the red series may become brighter due to the infrared rays, thereby causing the distortion of color.

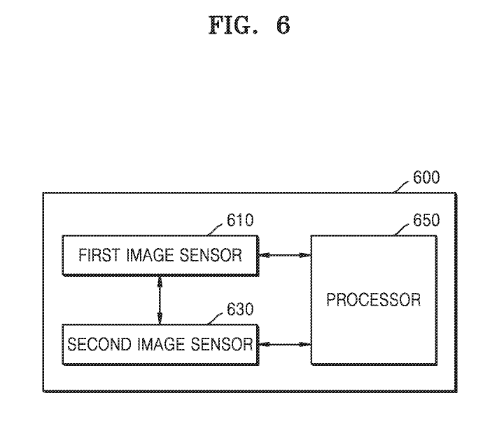

FIG. 6 is a block diagram illustrating an example photographing device according to an example embodiment. A photographing device 600 may include a first image sensor 610, a second image sensor 630, and a processor 650.

The first image sensor 610 may, for example, be a color image sensor that includes a color filter array (CFA). The first image sensor 610 may receive light, of which the infrared wavelength band is removed, of light incident on the photographing device 600 through a lens and may generate color image data based on the received light.

The second image sensor 630 may, for example, be a grey image sensor that does not includes a color filter array (CFA). The second image sensor 630 may receive light incident on the photographing device 600 through the lens and may generate grey image data based on the received light. Light incident on the second image sensor 630 may include infrared rays reflected from a subject without modification, for example, light of an infrared wavelength band may be included.

Since grey image data generated through the second image sensor 630 are generated using infrared rays, the resolution of the grey image data may be higher than that of image data generated without using infrared rays.

In an example embodiment, the photographing device 600 may further include an infrared cut-off filter. The infrared cut-off filter may be used for light incident on the first image sensor 610, without being used for light incident on the second image sensor 630.

The processor 650 may be configured to extract a first edge from the color image data that the first image sensor 610 generates and may be configured to extract a second edge from the grey image data that the second image sensor 630. In addition, the processor 650 may be configured to combine the first edge and the second edge to generate a third edge. The processor 650 may be configured to combine the third edge with the color image data, which the first image sensor 610 generates, to generate resultant image data.

In a photographing device that uses a plurality of sensors, a method of not directly combining pieces of image data, which the sensors generate respectively, but combining edges, may take advantage of the phenomenon that the color is scarcely distorted in the grey image data even though infrared rays are used and that data of higher resolution is obtained when image data is generated using infrared rays.

The photographing device 600 may combine the third edge with the color image data to generate resultant image data. For example, since the color image data is data generated without using infrared rays, the distortion of color shown in FIG. 5 may not appear. In addition, since the third edge is generated on the basis of the second edge of the grey image data that is generated using infrared rays reflected from a subject without modification, it may be possible to increase the resolution of image data.

A method of combining the first edge and the second edge will be described in greater detail below.

An example embodiment is illustrated in FIG. 6 as the first image sensor 610, the second image sensor 630, and the processor 650 are expressed by a separate configuration unit, respectively. However, in another example embodiment, the first image sensor 610, the second image sensor 630, and the processor 650 may be integrated into the same configuration unit.

In addition, in an example embodiment, the first image sensor 610, the second image sensor 630, and the processor 650 may be configured to be adjacent to one another. However, since devices for performing functions of the first image sensor 610, the second image sensor 630, and the processor 650 respectively need not be configured to be physically adjacent to one another, the first image sensor 610, the second image sensor 630, and the processor 650 may be configured to be spaced apart or separate from one another according to an example embodiment.

In addition, since the photographing device 600 is not limited to a physical device, a part of functions of the photographing device 600 may be implemented by software, not necessarily hardware.

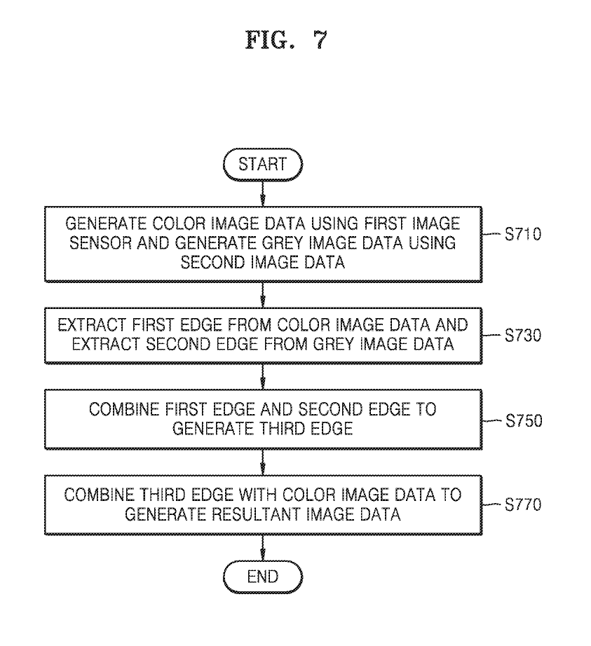

FIG. 7 is a flowchart illustrating an example method of controlling a photographing device, according to an example embodiment.

In step S710, the photographing device 600 may generate color image data using the first image sensor 610 and may generate grey image data using the second image sensor 630.

The first image sensor 610 that is an image sensor including a color filter array (CFA) may receive light, of which the infrared wavelength band is cut off, of light incident on the photographing device 600 through a lens and may generate the color image data based on the received light.

The second image sensor 630 that is an image sensor not including the CFA may receive light incident on the photographing device 600 through the lens without modification, for example, without removing an infrared wavelength band and may generate the grey image data based on the received light. The grey image data thus generated may have high resolution compared to image data generated after the infrared wavelength band of the incident light is cut off.

In step S730, the photographing device 600 may extract a first edge from the color image data and may extract a second edge from the grey image data. The extraction of the edges may be accomplished using various algorithms.

In terms of the resolution, the resolution of the second edge that is extracted from data generated using the infrared wavelength band may be higher than that of the first edge that is extracted from data generated without using the infrared wavelength band.

In step S750, the photographing device 600 may combine the first edge and the second edge to generate a third edge.

When combining the first edge and the second edge, the photographing device 600 may apply different weights to the first edge and the second edge, respectively. As an example, the photographing device 600 may apply a 60% weight and a 40% weight to the first edge and the second edge respectively on the basis of 100%. As another example, the photographing device 600 may apply a 20% weight and an 80% weight to the first edge and the second edge respectively on the basis of 100%.

In an example embodiment, the photographing device 600 may determine a weight of the first edge and a weight of the second edge, based on a difference between visible ray reflectance and infrared reflectance of a subject.

When a difference between visible ray reflectance and infrared reflectance of a partial area of the subject is greater than or equal to a threshold value, for example, the difference between the visible ray reflectance and the infrared reflectance of the partial area of the subject is great, the photographing device 600 may increase the weight of the first edge, which is extracted from the color image data, to minimize and/or reduce the distortion of the image.

In contrast, when a difference between the visible ray reflectance and the infrared reflectance of the partial area of the subject is less than the threshold value, for example, when the difference between the visible ray reflectance and the infrared reflectance is small, the photographing device 600 may increase the weight of the second edge, which is extracted from the grey image data, to increase the resolution.

In the same subject, a weight of the first edge and a weight of the second edge may be determined differently with respect to areas of which reflectance differences between visible rays and infrared rays are different from each other.

For example, in the case where a user photographs a face of any person, since the eyes, eyebrows, lips, and other parts have different visible ray reflectance and infrared reflectance, a weight of the first edge that is extracted from image data obtained by photographing each part may differ for each part, and a weight of the second edge that is extracted from image data obtained by photographing each part may differ for each part.

Visible ray reflectance and infrared reflectance of a subject may be obtained from a database in which a difference between visible ray reflectance and infrared reflectance is stored in advance for each subject or may be obtained from image data whenever photographing is made.

In an example embodiment, the photographing device 600 may combine the first edge and the second edge without applying weights thereto.

The first edge and the second edge may be combined in various ways, without being limited to the above-described example embodiments.

In step S770, the photographing device 600 may combine the third edge with the color image data to generate resultant image data. The color image data may be image data that the first image sensor 610 generates. Since the color image data is data that is generated using light which is transmitted through a lens and incident on the photographing device 600, and from which light of the infrared wavelength band has been filtered out, the color image data may be data in which the distortion of color due to the infrared rays does not appear.

The third edge may be acquired by combining, in step S750, the first edge and the second edge in various ways.

The resultant image data may be acquired by combining the third edge with the color image data. The resultant image data thus acquired may maintain brightness and color that a person originally perceives and may have higher resolution by utilizing the resolution of an infrared wavelength band.

The photographing device 600 may output the resultant image data in various ways.

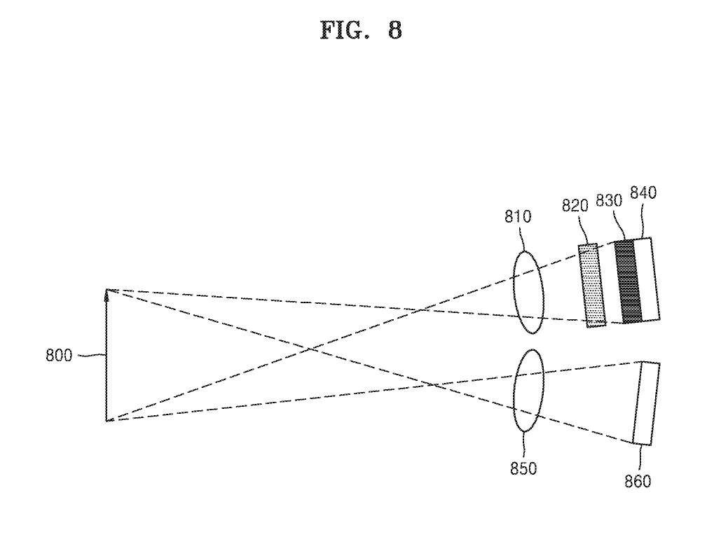

FIG. 8 is a schematic diagram illustrating an example photographing device equipped with a plurality of sensors, according to an example embodiment.

The photographing device 600 may receive light, which is reflected from a subject 800, through a first lens 810 and a second lens 850.

Infrared rays of light received through the first lens 810 may be cut off through an infrared cut-off filter 820, and the light of which the infrared rays are cut off may be converted into color image data through a first image sensor 840 that includes a CFA 830.

Light received through the second lens 850 may be provided directly to a second image sensor 860 without passing through the infrared removing filter 820 and the CFA 830, so as to be converted into grey image data.

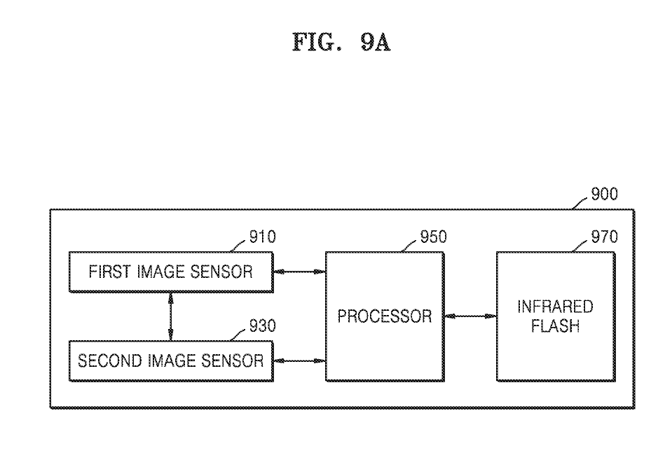

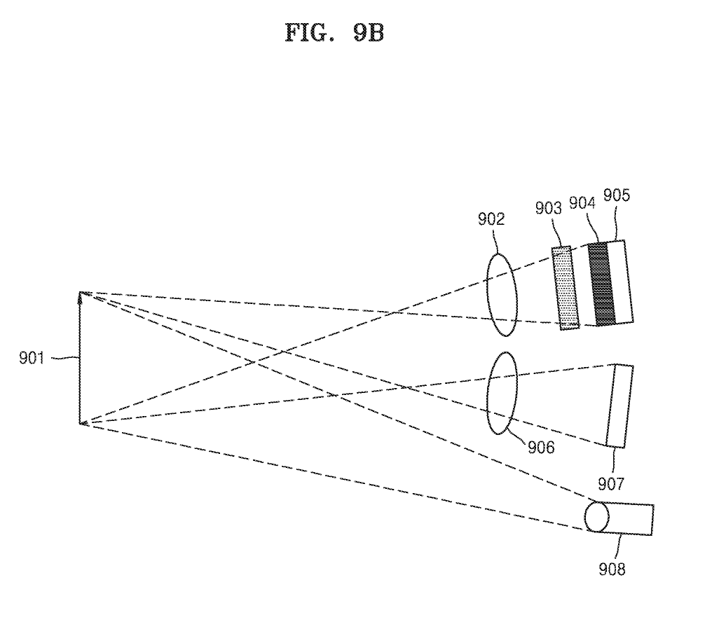

FIG. 9A is a block diagram illustrating an example photographing device according to an example embodiment.

A photographing device 900 may include a first image sensor 910, a second image sensor 930, a processor 950, and an infrared flash 970.

The first image sensor 910 may be an image sensor including a color filter array (CFA) may receive light, of which the infrared wavelength band is cut off, of light incident on the photographing device 900 through a lens and may generate color image data based on the received light.

The second image sensor 930 may be an image sensor not including a color filter array (CFA) may receive light incident on the photographing device 900 through the lens and may generate grey image data based on the received light. Light incident on the second image sensor 930 may be light of which the infrared rays are not cut off. The second image sensor 930 may receive infrared rays reflected from a subject without modification. The second image sensor 930 may generate the grey image data using infrared rays incident on the photographing device 900 through a lens.

The processor 950 may be configured to extract a first edge from the color image data that the first image sensor 910 generates and may be configured to extract a second edge from the grey image data that the second image sensor 930. In addition, the processor 950 may be configured to combine the first edge and the second edge to generate a third edge. The processor 950 may be configured to combine the third edge with the color image data, which the first image sensor 910 generates, to generate resultant image data.

The photographing device 900 may combine the third edge with the color image data to generate the resultant image data. Since the color image data is data that is generated without using infrared rays, the distortion of color illustrated in FIG. 5 may not appear. Since the third edge is generated by combining the second edge, which is extracted from image data generated using infrared rays reflected from a subject without modification, with the first edge, it may be possible to increase the resolution of image data.

The infrared flash 970 may radiate infrared rays on a subject when photographing it. In the case where the photographing device 900 radiates infrared rays to the subject through the infrared flash 970, the quantity of infrared rays reflected from the subject may be changed. In the case where the photographing device 900 radiates infrared rays to the subject through the infrared flash 970, the subject may reflect a great amount of infrared rays compared to the case where the infrared flash 970 is not used. The photographing device 900 may adjust the quantity of infrared rays to be radiated.

An example embodiment is illustrated in FIG. 9A as the first image sensor 910, the second image sensor 930, the processor 950, and the infrared flash 970 are expressed by a separate configuration unit. However, in another embodiment, the first image sensor 910, the second image sensor 930, the processor 950, and the infrared flash 970 may be integrated into the same configuration unit.

In addition, in an example embodiment, the first image sensor 910, the second image sensor 930, the processor 950, and the infrared flash 970 may be configured to be adjacent to one another. However, since devices for performing functions of the first image sensor 910, the second image sensor 930, the processor 950, and the infrared flash 970 respectively need not be configured to be physically adjacent to one another, the first image sensor 910, the second image sensor 930, the processor 950, and the infrared flash 970 may be configured to be spaced apart or separate from one another according to an embodiment.

In addition, since the photographing device 900 is not limited to a physical device, a part of functions of the photographing device 900 may be implemented by software, not necessarily hardware.

FIG. 9B is a schematic diagram illustrating an example photographing device equipped with a plurality of sensors, according to an example embodiment. An example embodiment of FIG. 9B may correspond to the case in which an infrared flash 908 is added to an example embodiment of FIG. 8.

The photographing device 900 may receive light, which is reflected from a subject 901, through a first lens 902 and a second lens 906.

Infrared rays of light received through the first lens 902 may be cut off through an infrared cut-off filter 903, and the light of which the infrared rays are cut off may be converted into color image data through a first image sensor 905 that includes a CFA 904.

Infrared rays of light received through the second lens 906 may be provided directly to a second image sensor 907 without passing through the infrared cut-off filter 903 and the CFA 904, and the light that includes the infrared rays may be converted into grey image data.

The photographing device 900 may further include the infrared flash 908. A part of light radiated from the infrared flash 908 to the subject 901 may be reflected from the subject 901, and the reflected light may be incident on the photographing device 900 again.

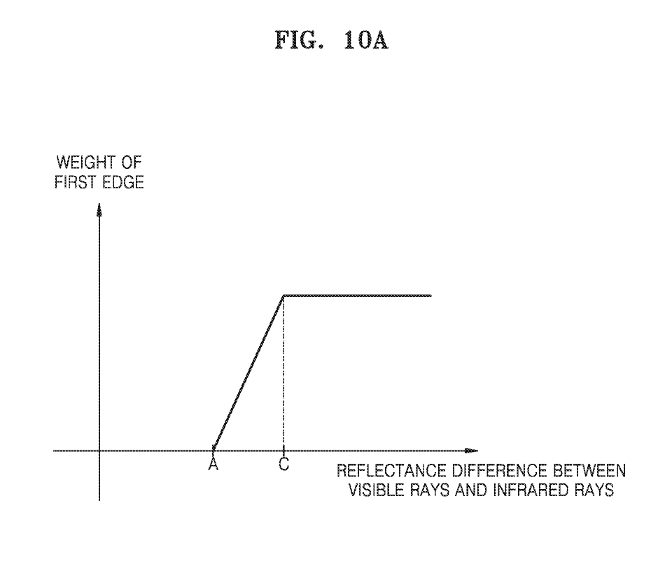

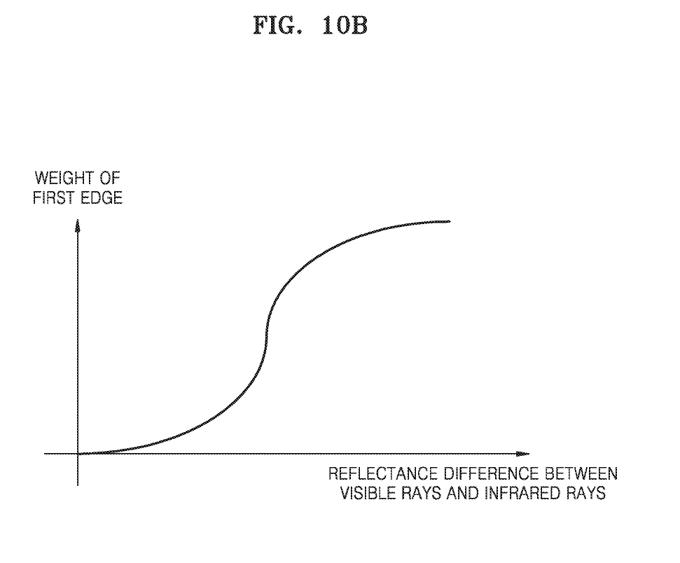

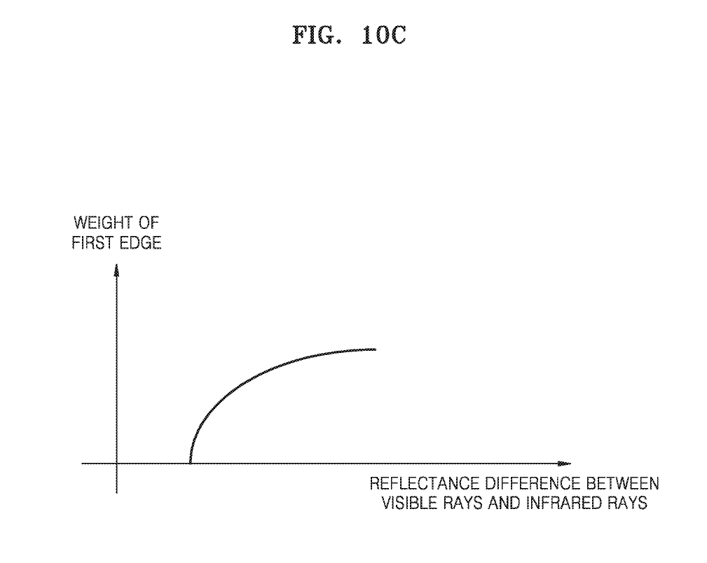

FIG. 10A is a diagram illustrating a method of determining a weight of a first edge based on a property of a subject, according to an example embodiment.

In the graph, the abscissa represents a difference between visible ray reflectance and infrared reflectance of each subject. The difference may refer, for example, to an absolute value, and the visible ray reflectance may be greater than the infrared reflectance or may be smaller than the infrared reflectance.

In the graph, the ordinate may refer, for example, to a weight of a first edge that is extracted from color image data generated through the first image sensor 610, e.g., a color image sensor. A weight of a second edge that is extracted from grey image data generated through the second image sensor 630, e.g., a grey image sensor, may have a value that is obtained by subtracting a weight of the first edge from “100” and may be determined automatically.

In the graph, “A” may refer, for example, to a threshold value that is associated with a difference between visible ray reflectance and infrared reflectance of a subject. In the case where the difference between the visible ray reflectance and the infrared reflectance of the subject is greater than the threshold value, that is, “A”, a weight of the first edge may be greater than that of the second edge.

As the difference between the visible ray reflectance and the infrared reflectance of the subject exceeds the threshold value, the weight of the first edge may increase in proportion thereto.

Here, the weight of the first edge may gradually increase until the difference between the visible ray reflectance and the infrared reaches a point C, but the weight of the first edge may not increase any longer when it reaches a magnitude.

FIG. 10B is a diagram illustrating a method for determining a weight of a first edge based on a property of a subject, according to another example embodiment.

A weight of the first edge may be changed, in an “S” shape, based on a difference between visible ray reflectance and infrared reflectance of a subject.

In the graph, the abscissa represents a difference between visible ray reflectance and infrared reflectance of each subject. The difference may refer, for example, to an absolute value, and the visible ray reflectance may be greater than the infrared reflectance or may be smaller than the infrared reflectance.

In the graph, the ordinate may refer, for example, to a weight of a first edge that is extracted from color image data generated through the first image sensor 610, e.g., a color image sensor. A weight of a second edge that is extracted from grey image data generated through the second image sensor 630 as a grey image sensor may have a value that is obtained by subtracting a weight of the first edge from “100” and may be determined automatically.

FIG. 10C is a diagram illustrating a method of determining a weight of a first edge based on a property of a subject, according to still another example embodiment.

A weight of the first edge may be changed, in a “logarithmic” shape, based on a difference between visible ray reflectance and infrared reflectance of a subject.

In the graph, the abscissa represents a difference between visible ray reflectance and infrared reflectance of each subject. The difference may refer, for example, to an absolute value, and the visible ray reflectance may be greater than the infrared reflectance or may be smaller than the infrared reflectance.

In the graph, the ordinate may refer, for example, to a weight of a first edge that is extracted from color image data generated through the first image sensor 610, e.g., a color image sensor. A weight of a second edge that is extracted from grey image data generated through the second image sensor 630, e.g., a grey image sensor, may have a value that is obtained by subtracting a weight of the first edge from “100” and may be determined automatically.

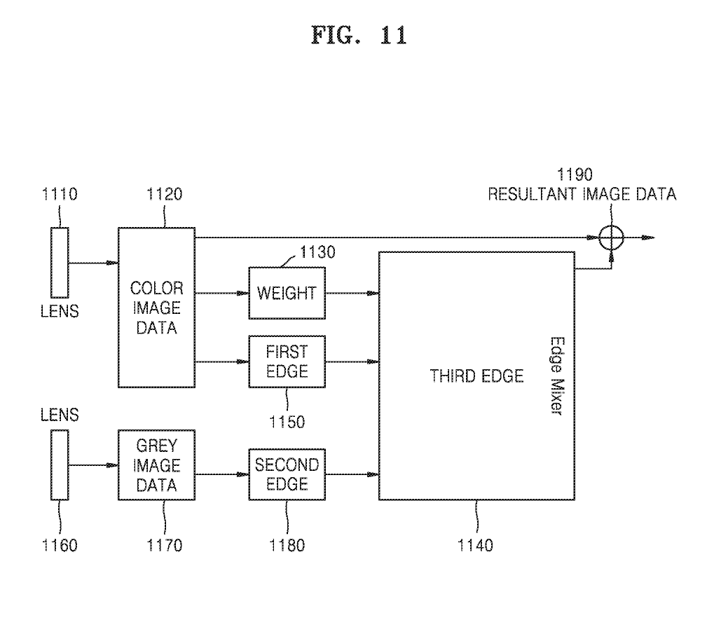

FIG. 11 is a block diagram illustrating an example photographing device equipped with a plurality of sensors, according to an example embodiment.

Light that is reflected from a subject and is incident through a lens may be converted into color image data 1120 through a first image sensor 1110, and light that is reflected from a subject and is incident through the lens may be converted into grey image data 1170 through a second image sensor 1160.

The photographing device 600 may extract a first edge 1150 from the color image data 1120. In addition, the photographing device 600 may extract a second edge 1180 from the grey image data 1170.

The photographing device 600 may acquire weight information 1130 of the first edge 1150, which is used in combining the first edge 1150 and the second edge 1180, from the color image data 1120.

The photographing device 600 may generate a third edge 1140 by combining the first edge 1150 and the second edge 1180 with reference to the weight information 1130.

The photographing device 600 may acquire weight information of the second edge 1180, which is used in combining the first edge 1180 and the second edge 1180, from the grey image data 1170.

In some example embodiments, the photographing device 600 may acquire the weight information 1130 of the first edge from the color image data 1120 and may acquire weight information of the second edge 1180 from the grey image data 1170. The photographing device 600 may finally determine weights of the first and second edges 1150 and 1180 with reference to the pieces of weight information in various ways.

The photographing device 600 may combine the color image data 1120 and the third edge 1140 to acquire resultant image data 1190.

Various example embodiments may also be embodied as computer-readable codes on a computer-readable recording medium. The computer-readable recording medium may be all kinds of storage devices that store data which can be thereafter read by a computer system.

The computer-readable codes may be configured to perform steps of an image processing method according to an example embodiment when the codes are read by a processor so as to be executed. The computer-readable codes may be implemented by various programming languages. Also, functional programs, codes, and code segments for accomplishing example embodiments may be easily construed by programmers skilled in the art to which the disclosure pertains.

Examples of the computer readable recording medium include read-only memories (ROMs), random-access memories (RAMs), CD-ROMs, magnetic tapes, floppy disks, optical data storage devices, and carrier waves (such as data transmission through the Internet). The computer readable recording medium may also be distributed over network coupled computer systems so that the computer readable code is stored and executed in a distributed fashion.

The above description of the present disclosure is provided for the purpose of illustration, and it would be understood by those skilled in the art that various changes and modifications may be made without departing from the scope and essential features of the present disclosure. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the example embodiments. It shall be understood that all modifications and embodiments conceived from the meaning and scope of the claims and their equivalents are included in the scope of the present disclosure.

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. A method of controlling a photographing device comprising a plurality of image sensors, the method comprising:
generating color image data from a first image sensor photographing a subject and generating grey image data from a second image sensor photographing the subject;
extracting a first edge from the color image data and extracting a second edge from the grey image data;
combining the first edge with the second edge to generate a third edge; and
combining the third edge with the color image data to generate resultant image data.

2. The method of claim 1, wherein the combining of the first edge with the second edge comprises:
determining a weight of the first edge and a weight of the second edge, respectively, based on a difference between a visible ray reflectance and an infrared reflectance of the subject; and
combining the first edge with the second edge based on the weight of the first edge and the weight of the second edge.

3. The method of claim 2, wherein the weight of the first edge is determined to be greater than the weight of the second edge when the difference between the visible ray reflectance and the infrared reflectance of the subject is greater than a threshold value, and
wherein the weight of the first edge is determined to be less than the weight of the second edge when the difference between the visible ray reflectance and the infrared reflectance of the subject is less than the threshold value.

4. The method of claim 2, wherein the weight of the first edge is determined differently with respect to areas in which reflectance differences between visible rays and infrared rays in the subject are different from each other.

5. The method of claim 2, wherein the weight of the first edge is determined based on the difference between the visible ray reflectance and the infrared reflectance of the subject obtained from the color image data or the grey image data.

6. The method of claim 2, wherein the weight of the first edge is determined based on the difference between the visible ray reflectance and the infrared reflectance of the subject obtained from a database.

7. The method of claim 1, wherein the grey image data is generated using infrared rays incident on the photographing device through a lens.

8. The method of claim 1, wherein the grey image data is generated by radiating infrared rays on the subject using an infrared flash.

9. The method of claim 8, wherein an amount of infrared rays radiated from the infrared flash is adjustable.

10. A photographing device comprising a plurality of image sensors, the photographing device comprising:
a first image sensor configured to generate color image data from a subject;
a second image sensor configured to generate grey image data from the subject; and
a processor configured to extract a first edge from the color image data, to extract a second edge from the grey image data, to combine the first edge with the second edge to generate a third edge, and to combine the third edge with the color image data to generate resultant image data.

11. The photographing device of claim 10, wherein the processor is configured to determine a weight of the first edge and a weight of the second edge, respectively, based on a difference between a visible ray reflectance and an infrared reflectance of the subject and to combine the first edge with the second edge based on the weight of the first edge and the weight of the second edge.

12. The photographing device of claim 11, wherein the processor is configured to determine the weight of the first edge to be greater than the weight of the second edge when the difference between the visible ray reflectance and the infrared reflectance of the subject is greater than a threshold value, and
wherein the processor is configured to determine the weight of the first edge to be less than the weight of the second edge when the difference between the visible ray reflectance and the infrared reflectance of the subject is less than the threshold value.

13. The photographing device of claim 11, wherein the weight of the first edge is determined differently with respect to areas in which reflectance differences between visible rays and infrared rays in the subject are different from each other.

14. The photographing device of claim 11, wherein the weight of the first edge is determined based on the difference between the visible ray reflectance and the infrared reflectance of the subject obtained from the color image data or the grey image data.

15. The photographing device of claim 11, wherein the weight of the first edge is determined based on the difference between the visible ray reflectance and the infrared reflectance of the subject obtained from a database.

16. The photographing device of claim 10, wherein the grey image data is generated using infrared rays incident on the photographing device through a lens.

17. The photographing device of claim 10, further comprising:
an infrared flash, and
wherein the grey image data is generated by radiating infrared rays on the subject using the infrared flash.

18. The photographing device of claim 17, wherein an amount of infrared rays radiated from the infrared flash is adjustable.

19. A non-transitory computer-readable recording medium having recorded thereon a program of performing the method of claim 1.
